(19) United States
(12) Patent Application Publication
(10) Pub. No.: US 2019/0325440 A1
(43) Pub. Date: Oct. 24, 2019

(54) PAYMENT REPORTING SYSTEM AND METHOD

(71) Applicant: Robert David Sager, Manhattan, KS (US)

(72) Inventor: Robert David Sager, Manhattan, KS (US)

(21) Appl. No.: 15/913,747

(22) Filed: Mar. 6, 2018

Related U.S. Application Data
(60) Provisional application No. 62/467,327, filed on Mar. 6, 2017.
(60) Provisional application No. 62/487,462, filed on Apr. 19, 2017.

(51) Int. Cl. G06Q 20/40; G06Q 40/08; G06Q 20/32

(52) U.S. Cl. CPC G06Q 20/405; G06Q 20/322; G06Q 40/08

(57) ABSTRACT

A method and system is provided for convergence of multiple independent applications into a single payment vehicle and for recording and reporting associated payments and available funds.

### CROSS-REFERENCE TO RELATED APPLICATIONS

This application claims priority pursuant to 35 U.S.C. 119(e) to co-pending U.S. Provisional Patent Application Ser. Nos. 62/467,327, filed Mar. 6, 2017, and 62/487,462, filed Apr. 19, 2017, the entire disclosures of which are incorporated herein by reference. This application also incorporates by reference U.S. application Ser. No. 14/095,731, filed Dec. 3, 2013, which is a continuation of U.S. application Ser. No. 11/381,099, filed May 1, 2006, now U.S. Pat. No. 8,600,770, which is a continuation of U.S. application Ser. No. 10/217,903, filed Aug. 13, 2002, now U.S. Pat. No. 7,039,593, which claims priority to U.S. Provisional Application Ser. No. 60/390,179, titled Payment Convergence System and Method, filed Jun. 20, 2002 by Robert David Sager, the entire disclosures of which are incorporated herein by reference.

### FIELD OF THE INVENTION

The present invention relates generally to a payment reporting system and method. More specifically, the present invention is concerned with systems for and methods of collecting information from multiple independent payment methods, some of which are bundled into a single payment vehicle for a single transaction and/or collecting information pertaining to payment convergence (such as at a point of sale (POS)) and other information about multiple independent payment options, including those using Smart Card technology and/or electronic wallet technology.

### BACKGROUND

Smart Card technology is currently in use in several industries, including healthcare, banking, entertainment, and transportation industries. A Smart Card is a plastic card similar to a credit card, which is embedded with a computer chip for storing and transacting data, such as a value or other information associated with the Smart Card and/or a user of the Smart Card.

There are two types of Smart Cards, memory cards and microprocessor cards.

Memory cards do not have any sophisticated processing power and are incapable of managing files dynamically. There are three primary types of memory cards: Straight Memory Cards, Protected/Segmented Memory Cards, and Stored Value Memory Cards.

Straight Memory Cards simply store data and have no data processing capabilities, they are analogous to floppy disks of varying sizes. Straight memory cards do not have any mechanism to lock the data; thus anyone with a reader can access the data stored on the card.

Segmented Memory Cards have built-in logic to control user access to the memory of the card. Data stored on such a Smart Card is protected through a password or system key. Segmented Memory Cards can be divided into logical sections to provide for planned multi-functionality of the card.

Stored Value Memory Cards are used for storing value or credits. These cards can be either disposable or rechargeable and usually incorporate permanent security devices such as password keys and logic that are hard-coded into the chip by the manufacturer. The memory on these types of Smart Cards is essentially set up as a counter. For example a telephone card may have twelve memory cells, one for each minute of talk time. One memory cell is cleared each time a minute of telephone talk time is used. Once all twelve memory cells are cleared, no more talk time is available and the card is either discarded or recharged with more talk time.

Unlike memory cards, microprocessor cards have on-card dynamic data processing capabilities that permit the combination of multiple applications onto a single card. For example, a single Smart Card can function as an individual's driver's license, their credit card, their phone card and their health insurance card. These multiple-application Smart Cards are usually “co-branded” with the names of each of the individual companies utilizing an application on that Smart Card (i.e. credit card company, phone company, health insurance company, etc).

An important feature of these multi-application Smart Cards is that the information relating to each individual application be kept separate from the other applications, and that the appropriate information only be available for use with its intended application. For instance, the information that is available to a merchant where a purchase is being made should only include the individual's credit card number, and should not include any information necessary to make long distance phone calls or the individual's health insurance information. Each application must be kept separate for security and privacy reasons.

For some time now, Smart Cards have been used in the health insurance industry to help process and settle routine medical claims. The use of the Smart Cards in a health insurance application provides tremendous benefit in being able to simplify and automate eligibility information and co-payment information on the spot. Prior to the use of Smart Cards, a clinic's office staff would make photocopies of a patient's insurance card and call an 800 number to verify coverage. One swipe of a Smart Card connected to an insurer's computer system can provide assurance that the patient is eligible for treatment, the amount of the associated co-pay, and any restrictions in the payment of fees.

Because of the importance of maintaining a separation between multiple applications located on a single Smart Card, the prior art usage of Smart Card technology has been a strictly “horizontal” referencing and updating of information and instructions for each application independently. Currently no system exists for “vertically” combining information from the independent applications of a multiple application Smart Card, or for “vertically” combining information from independent applications of any other card with multi-functionality. For example, a single Smart Card might include multiple applications such as a credit card and a health insurance card. Theoretically, using such a multi-application Smart Card of the prior art, a healthcare subscriber could utilize both the healthcare application and the payment application to allow the provider to obtain both the insurance coverage portion and the patient's co-pay portion for a procedure. Nevertheless, the provider would be required to have appropriate equipment and security codes to access both applications. Additionally, the provider would have to access each application independently, or horizontally. First the provider would have to access the healthcare application to determine policy coverage and amount of co-payment required, and then separately access the payment application to obtain the patient's co-payment. Such would require considerable time and expense to the provider due to equipment needs, paperwork and manpower. Even more time and resources would be utilized if a third application, such as a healthcare line of credit account, is included on the card.

Basically the multiple-application Smart Cards (or any other cards with multi-functionality) of the prior art act only to eliminate the need of the card holder to carry a separate card for each application. Using such a card of the prior art, the card holder can have insurance policy information, healthcare line of credit account information, and credit card information all on a single card. Unfortunately, when the cardholder goes to the doctor's/dentist's office and presents the card, the healthcare provider will be required to perform manually separate checks for each application that is to be utilized. Once the medical/dental procedure is determined, the healthcare provider will need to phone, fax or email the patient's insurance company to determine whether the procedure is covered, and the amount of payment that the provider will be eligible to receive from the insurance company for the procedure. Once the amount of payment to be expected from the insurance company is determined, the provider will then have to independently phone, fax or email the healthcare line of credit company to determine how much payment the provider can expect from that source. Finally, if the insurance company payment amount combined with the line of credit amount is not enough to cover the entire cost of the procedure, the provider must collect the remainder of the costs from the patient. If the patient chooses to pay by credit card, the provider must obtain authorization for credit (holding against a line of credit, also referred to as blocking or reservation of funds) and complete settlement of funds in the traditional manner of usage for a credit card. A convergence system and method, as described in U.S. Pat. Nos. 7,039,593 and 8,600,770, the entire disclosures of which are incorporated herein by reference, provide a superior system for and method of allowing a healthcare provider to avoid the time and expense of performing these multiple checks independently.

Determining the amount of payment to be expected from the insurance company by itself can be a fairly complex procedure based upon a co-pay percentage, co-pay limits, and policy limits. For example, a dental policy may have a $3000 yearly policy limit. Additionally, the patient's co-pay might be 20% up to a maximum out-of-pocket of $250. Using this example for a first procedure costing a total of $1000, the insurance company would pay 80% ($800) and the patient would pay 20% ($200). Continuing with the same example for a second procedure costing a total of $2000, the patient's 20% portion ($400) would cause the patient's total out-of-pocket expenses to exceed the $250 maximum. Consequently, the insurance portion would increase to 100% upon the patient's total out-of-pocket expenses reaching the maximum out-of-pocket value. This leaves a total paid by insurance of $1950 for the second procedure, and a yearly total of insurance benefits of $2750. Still continuing with the same example for a third procedure costing $1000, the insurance portion would continue to be 100% until the policy limit of $3,000 is met, at which time the insurance portion would go to 0%, leaving the remainder for the patient to pay despite the patient already meeting the maximum out-of-pocket amount for the year. In an alternative example having the same co-pays and limits, an insurer and a patient would pay $800 and $200, respectively, for a first transaction of $1,000, based on their respective payment percentages of 80% and 20%, but their respective payment percentages would change for a second transaction of $3,000. For instance, the insurance payment percentage would be 80% for the first $250, 100% for the next $2,000, and 0% for the final $750, for a total insurance portion of $2,200 of the $3,000, which is an average insurance contribution percentage of 73.3%. Consequently, in some scenarios, a simple comparison of an insurance portion with a total amount could be insufficient information for a patient to determine whether the insurance portion is accurate. In other scenarios, it may be difficult or impossible for a patient to determine which portion of a bill was paid by insurance, which portion of the bill was paid by the patient, and/or why the patient and the insurer paid their respective portions.

As complicated as the above examples appear, they become even more complicated when more than one insurance provider is involved, when more than one patient is insured by one or more insurance plan (often triggering individual benefits and family benefits considerations), and/or a patient utilizes more than one payment source for any patient portion. Furthermore, any changes or conditions associated with one factor associated with one or more insurance provider and/or patient payment source, such as co-pay percentage, maximum out-of-pocket, policy limit, and the amount of benefits already utilized by the patient, can make a scenario even more complicated, and sometimes even impossible, for a patient to determine whether an insurer's portion of a payment was accurate, especially when all of this information is not readily available to the patient. Often, under the current system, a patient will only be given part of this information, such as the co-pay percentage and the policy limit and/or the insurance portion and the total amount. The patient may not fully understand how insurance benefits were utilized and/or may otherwise not have access to a timeline of when certain amounts of the benefits were utilized, thus making it impossible for the patient to determine whether the amount of an insurance payment was accurate. Additionally, if the patient does know the amount of benefits already utilized at the time a first procedure was performed, but the first provider submits a claim for benefits to the insurance company through the traditional paper form channels, it is possible that another claim for a second procedure could be processed and paid before the claim for the first procedure, despite the first procedure occurring before the second procedure. Such a scenario could change the amount of benefits utilized for the first procedure, making it even more difficult for the patient to determine whether the insurance portion for the first procedure is accurate. Thus, it would be beneficial if the patient could determine why a particular amount of benefits was utilized for a particular procedure and whether the amount of payment from the insurance company was accurate. Additionally, it would be beneficial if the patient could determine an amount of benefits remaining prior to having a procedure to ensure that the patient is able to provide payment of the full amount for the procedure, through insurance coverage and/or otherwise.

As political pressures increase to provide even more options to patients, the above concerns become amplified, and additional concerns are raised. For instance, it may be difficult or impossible for a patient or other interested person to discern all of the potential payment sources available at the time of a payment and/or to otherwise determine how payments were made, why the payments were made in a certain way, and/or whether the payments were made correctly and/or in a manner that was in the patient's best interests. Furthermore, continuing with either of the prior scenarios, it may be unclear what portion of the patient's payment portion can be itemized on the patient's tax return and which portions, if any, were paid with pre-tax money. For instance, some patients have health savings accounts or other pre-tax payment sources that allow the patient to make payments using pre-tax monies, thereby effectively decreasing the overall cost of one or more procedure and/or, in some scenarios, eliminating the need to itemize medical expenses on a tax return. In some scenarios, however, a patient's payment portion at the time of a payment may exceed the funds available to the patient from such payment sources for such payments. Consequently, the remainder may be taken from another pre-tax payment source and/or a post-tax payment source. Under such scenarios, it would be beneficial for a system to record each amount obtained by each payment source and provide sufficient information, such as amount available from such source and/or from other sources at the time of such payment, so that a patient or other interested person can determine whether such amount was accurate and/or beneficial. In other scenarios, all or part of a payment amount may not be tax-deductible, in which case it would be beneficial for a patient or other interested person to have sufficient information to determine which portions, if any, of a payment is tax-deductible so as to allow such person to determine whether a proper payment source was utilized and/or how much, if any, of the payment amount can be itemized.

### SUMMARY

A principal object of the present invention is to provide a payment reporting system and method that assists patients in determining insurance coverage information and/or other benefits and/or balance information while also ensuring the ability to provide payment for procedures, or portions of procedures, that are not covered by one or more insurance policy of the patient.

Another object of the present invention is to provide a secure system that reports, or otherwise makes available in a single application or other reporting method, multiple types of information including but not limited to payment methods for patient co-pay portion of a procedure, patient insurance benefit information, and third party co-pay information.

Another object of the instant invention is to enable a patient to determine the amount of payments from multiple independent sources, in connection with one or more transaction, and to determine whether such payments were accurate.

Yet another object of the instant invention is to provide a system that collects and reports on information pertaining to one or more bundled product by collecting and reporting on information associated with merging a person's insurance benefits with pre-approved credit, thereby providing a patient with a full picture of funds available for one or more potential medical procedure.

The above objectives are achieved by collecting and reporting on information associated with multiple independent payment sources/options, including those associated with a single payment vehicle for a single transaction. First, a total cost for the transaction (“transaction total”) at the point of sale is recorded. Then information regarding the method of payment for the transaction (“convergence information”) is obtained at the point of sale. Once the appropriate convergence information has been obtained, a processing that utilizes the convergence information is capable of being performed to determine the amount of payment to be received from each payment source to satisfy payment for the transaction total. Payment is then capable of being collected from each payment source in the amounts determined, with the amounts being recorded for future reporting, such as to a patient or other interested party.

As an object of the invention is to record and report on payments obtained from multiple independent sources, current Smart Card and/or electronic wallet (or combinations thereof) technology serves as a convenient medium for storage of information regarding the payment sources. Information about multiple payment sources is capable of being stored at different locations on the same Smart Card or other device (e.g. a smart phone). Nevertheless the convergence information is capable of being contained in numerous forms. For example, in some embodiments convergence information is maintained on a magnetic strip card or even in the form of a number. In some embodiments, the convergence information is even a “code” that is input into a point of sale terminal, providing the terminal sufficient data/instructions to take action to process the transaction. In some such embodiments, the “code” provides all information necessary for the terminal to process a transaction. In other embodiments, the code provides the terminal information sufficient for the terminal to “look up” more complete instructions located at a remote server or other remote location. Convergence information in the form of a number would be similar to that of a vehicle identification number, wherein the location of a digit in a number has significance. In this way, the system of the present invention is able to determine one or more payment from one or more payment source, effectuate such payments in such payment amounts and/or in other payment amounts, record calculated payment amounts and actual payment amounts, and report all or some such information to a patient or other interested party.

Reported information can include convergence information, such as data, processing instructions, or both data and processing instructions. The data can include information about the payment sources utilized for one or more payment and/or available for such payments and/or other payments, such as payment sources for which the party attempting to make payment has a relationship (“primary payment source information” and “secondary payment source information”), such as contact information for the payment sources, member identification numbers, policy terms, credit limits, payment amounts, etc. The instructions can include information associated with the interrelation and interaction between the multiple payment sources. These instructions can include such information as an order for which payment sources were utilized, an order for which payment sources should have been utilized, an order for utilizing the various payment sources in the future, and/or any timing considerations for utilizing such sources. The reported information does not necessarily include all information about the payment sources. In such a situation the data (such as convergence information) held on the Smart Card or other data storage device, such as a smart phone or the like, can be used to supplement the reported information, such as being used as the “key” for data lookup via “Host Networks” of the payment sources.

Although the system and method of the present invention provides a superior method of recording and reporting health-related information, it is understood that the system and method can be utilized to provide superior recording and reporting information for a variety of complicated financial and other matters, thereby providing a user with a single reliable source of useful information associated with numerous payment sources and/or numerous payment amounts.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

A preferred embodiment of the invention, illustrative of the best mode in which the applicant has contemplated applying the principles, is set forth in the following description and is shown in the drawings and is particularly and distinctly pointed out and set forth in the appended claims.

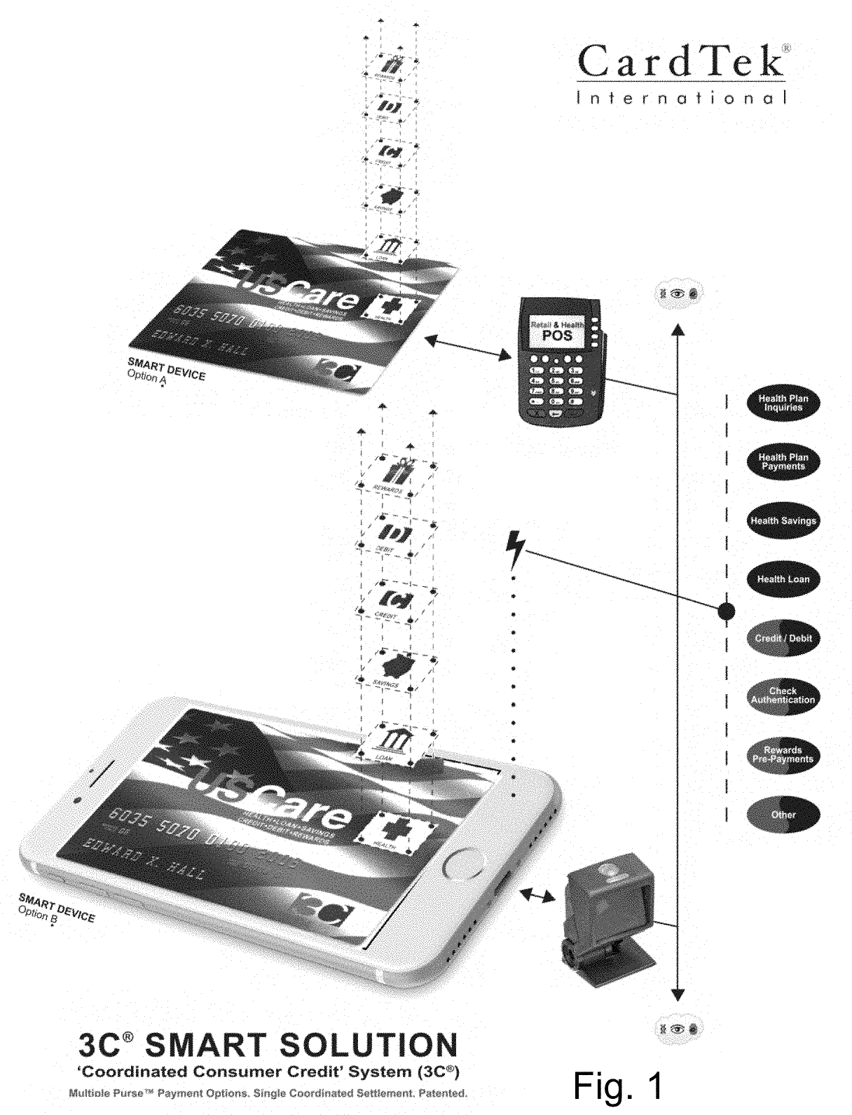

FIG. 1 is a pictorial illustration of different embodiments of a multiple application Mobile Data Storage Device of the instant invention.

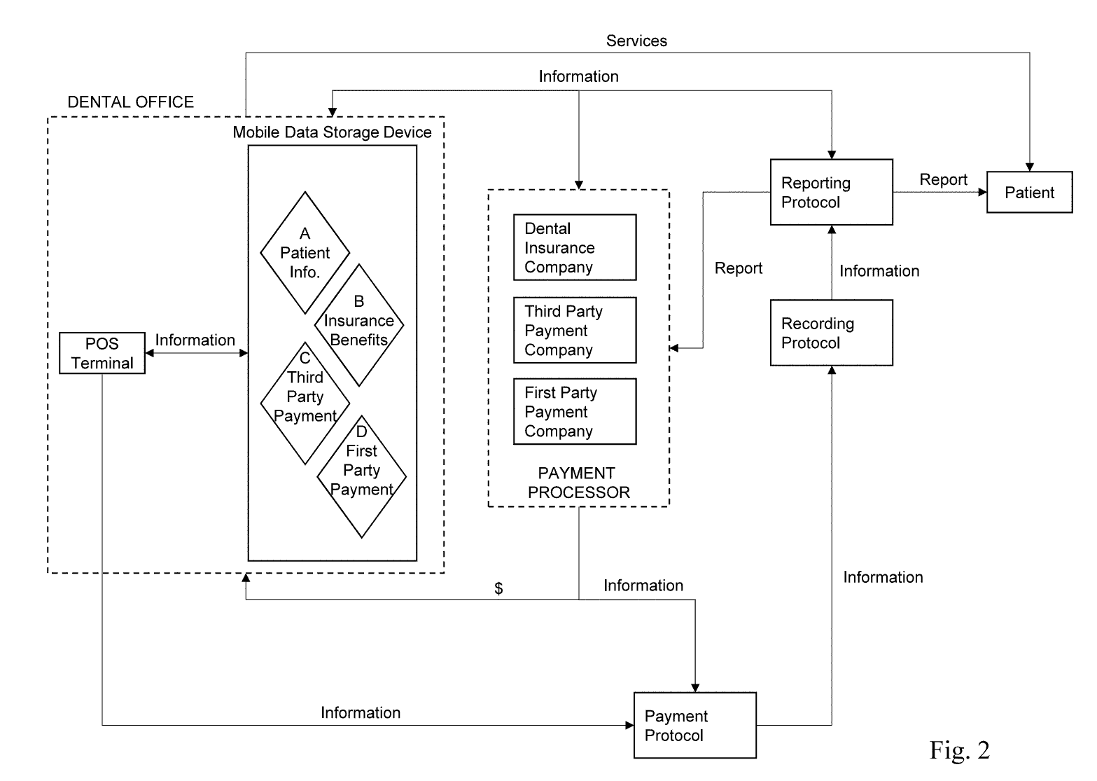

FIG. 2 is a diagram showing the vertical and horizontal convergence of multiple applications of the instant invention, including recording and reporting functionality for such payments.

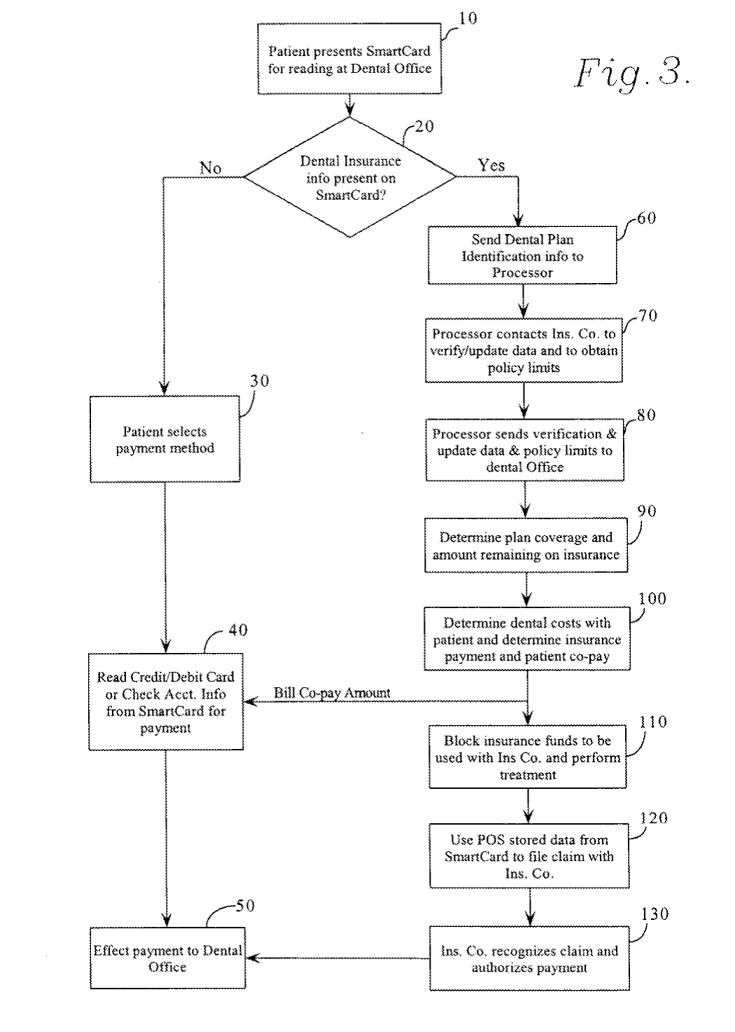

FIG. 3 is a flowchart showing one possible embodiment of the instant invention that correlates with an insurance benefit application and a first party/patient payment application.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The instant invention provides a system that allows for recording and reporting on numerous payment sources associated with one or more transaction, such as a convergence payment in which interrelation and interaction of multiple applications, such as those associated with a portable electronic device, a Smart Card, or any other feasible data storage medium now known or later developed, including but not necessarily limited to a code or other identifier that is input by a user at a point of sale terminal (hereinafter, collectively, “Mobile Data Storage Device”), to perform a complex processing and a distributed processing of all the information stored in the various applications of the Mobile Data Storage Device.

Although the preferred embodiment of the inventive system is illustrated in the context of a dental insurance plan, the instant invention can be applied to any form of medical coverage and performance of medical procedures, or even any other situation in which multiple independent applications may be utilized to accomplish a single outcome. For example, the instant invention could be applied to the purchase of a vehicle, which often requires financing approval and payment from a bank, as well as partial payment or money down from the purchaser.

In the preferred embodiment, a dental patient will have a Mobile Data Storage Device that includes information contained on the patient's insurance card, but also includes information that is not normally contained on an insurance card. In some embodiments, the Mobile Data Storage Device of the instant invention is generally referred to as a convergence device. The convergence device may include the patient's personal information such as name, address, PIN, etc. and the patient's dental insurance information, such as plan identification number, insurance company contact information (or a link to the insurance company), insurance eligibility, plan information and insurance status (i.e. amount left to reach policy limits or co-pay maximums, etc.). Along with insurance information, some embodiments of the Mobile Data Storage Device also have information about the patient's desired method to affect payment of the patient's co-pay obligation (first party payment method). The patient's preferred payment method could be a credit card, debit card, check, electronic benefits transfers (EBT), gifts, loyalty or prepayments. The Mobile Data Storage Device can also include information about third party payments such as health savings accounts, secondary insurance providers, insurance settlements, government assistance, and private credit.

FIG. 1 shows a pictorial illustration of different embodiments of a multiple application Mobile Data Storage Device of the instant invention. To better illustrate the instant invention, In FIG. 1, each application is shown as a vertical layer that is stacked on the Mobile Data Storage Device. Although the information stored on the Mobile Data Storage Device of the instant invention is illustrated as “vertical layers”, it is understood that the actual physical storage of information on a Mobile Data Storage Device can be accomplished in a single storage location with data being stored either randomly or sequentially. Each layer contains a different type of information that can be used independently from the information of all other layers. In the illustrated embodiment there are four layers: A) Card Holder Information, B) Insurance Benefit Information, C) Third Party Payment Information, and D) First Party (Card Holder) Payment Information.

Card holder information includes name, address, phone, social security number, and so forth.

Insurance benefit information includes insurance policy identification information (account number), plan information, subscriber/patient information, secondary coverage information (i.e. partial coverage from a spouse's insurance policy, etc.), policy limits, co-pay percentages, eligibility information, amount of policy limits and co-pay caps utilized, and any other information relating to insurance coverage.

Third party payment information includes any insurance coverage that is secondary to the primary insurance policy, as well as any private credit (line of credit) accounts for healthcare, any cafeteria plans, health savings accounts and other such accounts, governmental assistance, social security, gifts certificates, charitable gifts, prepayments, loyalty credit (i.e. credit earned for customer loyalty, similar to frequent flyer program), or any other source that is not the primary insurance company and is not a direct payment from the patient.

First party payment information includes any payment that is directly funded by the patient, such as the patient's credit card account, debit card, check, EBT, or any other account in which the funds are controlled by the patient.

As is shown in FIG. 1, the Mobile Data Storage Device of the instant invention can be co-branded to include multiple applications that can be utilized independently from one another. In the illustrated embodiment, the card is co-branded as a credit card and as a dental insurance card. The credit card information can be used independently from the dental insurance information. For example, the card holder can use the card to make a purchase at a department store just as they would use their credit card. The purchase will be invoiced on the card holder's credit card statement, and not be in any way associated with the card holder's dental insurance policy. Note that the Mobile Data Storage Device of the instant invention does not necessarily contain multiple applications or have to be co-branded (i.e. insurance card and credit card), it can be a single medical coverage application that includes a patient's credit card and insurance company information as part of the patient's medical coverage information. For example, if the card holder's preferred payment method (first party payment) for co-pay is the patient's credit card, the patient's credit card number and other essential information (i.e. expiration date, billing address, etc.) will be stored on the Mobile Data Storage Device for access by the dentist as the first party payment source. In such a situation, any other merchant (non-dentist) cannot access the first party payment information to make a traditional credit card payment.

Further note that even if the card of the instant invention is co-branded with a credit card company, or some other first party payment company, use of the co-branded first party payment source is not necessarily required by the instant invention. For example, if an insurance card is co-branded with a credit card, the card holder might chose an entirely different payment source, such as EBT, to effect payment of the co-pay portion of a procedure.

FIG. 2 shows the vertical and horizontal convergence of multiple applications of the instant invention. As is shown in FIG. 2, the Mobile Data Storage Device will contain multiple layers of information. As is discussed above, these multiple layers of information each contains information that is useful to the cardholder independent of all other information contained in the other layers. For example layer B, insurance benefit information, is useful by itself to provide the dentist/medical provider with information about the card holder's insurance policy so that the dentist knows how and where to bill for payment for a medical procedure. In a similar fashion, layer D, first party payment information, is useful by itself to effect payments for other purchases made away from the dentist's office. As is discussed above, the information contained in each layer might be accessible individually for use outside the dentist's office if the card is co-branded.

In FIG. 2 it is shown how the card allows information to flow horizontally. For example, insurance plan information can flow from the insurance provider to the dentist as is already done in the prior art. Additionally, as has been done in the prior art of credit cards, etc., authorization for funds can be obtained and settlement can be accomplished for services provided by the dentist. FIG. 2 also shows how the system of the instant invention allows information to flow vertically. As is shown in FIG. 2, information from the independent applications/layers is converged together to perform complex distributed processing which results in payment to the dentist for the entire dental procedure. The amount of insurance coverage can be determined along with the amount of any third party payments and then the amount of co-pay that must be paid by the patient. Payment can then be collected from all sources—insurance company, third party and patient.

In some embodiments, the system of the present invention includes one or more logical structure, such as a payment protocol for determining payment source amounts based on information obtained from the Mobile Data Storage Device and/or other sources. For instance, in some embodiments, the logical structure determines an amount associated with a current or potential future procedure (hereinafter, a “Current Procedure”), determines payment sources potentially available for the Current Procedure, and determines one or more payment amounts associated with the payment sources. In some such embodiments, the payment amounts and/or information pertaining to the calculation of the payment amounts are recorded on a payment protocol. In some embodiments, the payment protocol is utilized in obtaining the payment amounts. In other embodiments, the payment protocol is compared with additional payment information to verify accuracy of payments, including to verify when payments are made and/or to discover potential payment discrepancies.

Some embodiments of the present invention further include one or more recording protocol. In some embodiments, the recording protocol receives information from one or more payment protocol for one or more patient and/or one or more procedure for future reference. In some embodiments, information from one or more recording protocol is made available to one or more reporting protocol, the reporting protocol being configured to report payment information to a patient or other interested party so as to facilitate a thorough and accurate review and understanding of payments that have been made from various payment sources, payment obligations associated with each payment source, as applicable, and availability of funds from one or more current or potential payment source. In some embodiments, said one or more recording protocol comprises an application on the Mobile Data Storage Device (such as an app on a Smart Phone, or an app on a Smart Card) that collects data as the payment system of the inventive concept is used. In other embodiments, information regarding transactions is gathered in a separate database accessible by the patient (or other user of the system). In some embodiments, this is done by one or more processors of the information. In other embodiments, transaction data is reported to a separate storage location and accumulated for review by the patient.

In some embodiments, the reporting protocol further reports upon pertinent information associated with one or more current or potential relationships that exist between a payment source and one or more patient and/or one or more service provider. In some such embodiments, the reporting protocol obtains information about relationships that exist between the card holder and financial service providers such as the dental insurance company, first party payment companies, and third party payment companies, from a Mobile Data Storage Device. The card holder/patient has a relationship with the dental insurance company in the form of the insurance plan (subscriber contract), wherein the insurance company already has paid and/or agrees to pay for certain dental procedures performed on the patient. The patient also has relationships with the first party payment companies and third party payment companies as a customer through credit/debit accounts, checking accounts or other similar payment methods. These relationships provide that the payment companies have and/or will make payments on behalf of the patient as a payor in the amounts desired to the persons desired by the patient.

The Patient and dentist have a relationship wherein the dentist is to perform a dental procedure on the patient in exchange for payment. The information about the relationships between the patient and the financial service providers enables relationships between the dentist and the financial service providers. The dentist uses the information stored on the Mobile Data Storage Device to contact the financial service providers to obtain payment from the financial service providers on behalf of the patient. As is shown in FIG. 2, the dentist's office and the financial service providers exchange information and payment through the assistance of a Payment Processor. The Payment Processor has relationships with the dentist, the first party payment companies, the third party payment companies, and the insurance company. The Payment Processor of the instant invention can either be a single entity that has relationships with all relevant parties, or alternatively, the Payment Processor of the instant invention can actually comprise multiple Payment Processors each having relationships that assist in enabling the relationships between the parties. For example one Payment Processor may act as a clearing house for transferring payment information between the first party payment company and the dentist. A separate Payment Processor may act as a clearing-house for transferring information between the dentist and the insurance company. An indirect relationship exists between the patient/card holder and the Payment Processor wherein the patient is a beneficiary of the relationships between the other parties and the Payment Processor. It is also possible that the relationship between the dentist and the insurance company (or other financial service providers) can be accomplished through a direct line to those companies rather than through a Payment Processor. In either case, some embodiments of the present invention include providing payment information to the payment protocol, the recording protocol, and/or the reporting protocol so as to facilitate recording and/or reporting payment information. In some such embodiments, information from the payment protocol, the recording protocol, and/or the reporting protocol are used to validate and/or update information on the Mobile Data Storage Device.

As is discussed above, the Mobile Data Storage Device contains all the information about the patient (i.e. name, address, etc.) and the patient's relationships with the insurance company, the banks and any third party (i.e. healthcare line of credit) payment companies. This information essentially enables the relationships between the dentist and the insurance company, and the dentist and the first party payment company, etc., and allows for the transfer of information between these parties. Initially, all this information provides the dentist with basic information about the patient to allow the patient to initiate a relationship with the dentist. After the relationship is initiated between the patient and the dentist, the Mobile Data Storage Device provides the dentist with updates of all essential information. The updated information can be information stored on the Mobile Data Storage Device, information transmitted to the dentist's office from the insurance company (or bank or other financial service provider) in a transmission enabled by contact information on the Mobile Data Storage Device, or a combination of both. The Mobile Data Storage Device provides the dentist with information necessary to contact (through the Processor) the insurance company, third party payment company, and first party payment company to make a sequence of inquiries and answers.

Examples of inquiry and answers between the dentist and the insurance company, third party payment/credit company and first party payment company include: identification of the patient and the patient's account with each respective company; verification of information on the Mobile Data Storage Device, predetermination of eligibility for benefits/payment, authorization for payment, issuance of payment and update of information about the patient and its relationships.

The POS terminal at the dentist's office may access the Mobile Data Storage Device in several phases, first to set up a patient's account and update patient information about the dental plan, the private credit plan (third party payment method) and the first party payment method. The dentist will also access the Mobile Data Storage Device via the POS terminal to predetermine what benefits will be obtained from each source for a specific procedure prior to treatment and establish the relationships between the dentist and the insurance company and other payment companies based upon the patient's prior relationships. The dentist can then perform the treatment, and bill for services. If additionally services are required that were not anticipated initially, the dentist can again use the Mobile Data Storage Device to predetermine what benefits will be obtained from each source before performing the additional procedure. Once the procedure is complete the dentist will use the Mobile Data Storage Device information to obtain payments from all sources in the respective amounts that were predetermined. Payments can be submitted directly from the payment sources to the dentist (or the dentist's bank account).

The flowchart of FIG. 3 shows one possible embodiment of the instant invention as it is implemented at a dentist's office utilizing two applications/layers, insurance and first party (patient) payment. This embodiment shows a series of inquiries and answers that might be transmitted through the instant invention. In step 10 the patient goes into the dentist's office for treatment and initially presents the Mobile Data Storage Device to the dentist who has appropriate equipment to read the information contained on the card (POS machine). The dentist will see if dental insurance plan information is available on the Mobile Data Storage Device in step 20. If the Mobile Data Storage Device does not include dental insurance information, the patient will select a non-insurance payment method in step 30. If the appropriate payment information selected by the patient is available on the Mobile Data Storage Device, that information will be accessed by the dentist's POS device in step 40, and then payment will be effected to the dentist in step 50 through a Processor using the patient's payment information.

If the patient's Mobile Data Storage Device does contain dental insurance information, that information will include a dental plan Identification information, such as an identification number. In step 60, the dentist's Mobile Data Storage Device reader (POS device) will send the patient's dental plan Identification information to Processor. The Processor then contacts the patient's insurance company in step 70 to verify and update the data contained on the patient's Mobile Data Storage Device, and to obtain additional insurance information not provided on the Mobile Data Storage Device, such as policy limits. In step 80 the Processor will send the data obtained from the insurance company back to the dental office. The POS device at the dentist's office will then determine whether the desired dental procedure is covered by the patient's dental insurance in step 90. If the procedure is covered by the patient's insurance, the amount of coverage and the co-pay amount required to be paid by the patient will be determined in step 100. In the preferred embodiment this will be done by an automated system through the POS terminal. Alternatively, this step can be accomplished manually by the dentist and patient, or automatically on the Mobile Data Storage Device itself, if appropriate processing capability is available. Alternatively, the insurance company can determine the amount of co-pay required by the patient and transmit that amount to the provider. The patient's co-pay will be obtained through steps 40 and 50 discussed above.

In step 110, the dentist office will obtain authorization for the amount of insurance funds to be used for the patient procedure to be performed by the dentist. This will ensure that policy limits are not exceeded before the procedure is complete, and that the amount of co-pay required by the patient does not change.

In step 120, the dentist's POS device will use the patient's information stored on the Mobile Data Storage Device to file a claim with the insurance company. This claim can be filed electronically through a Processor (this is the most efficient use of Mobile Data Storage Device technology) or it can be printed and filed in the more traditional paper format. In some cases the claim might be filed electronically with a Processor that prints the claim and files the claim with the insurance company in paper format. The claim will usually be filed after the dental procedure is complete, which might be at the same time as the funds are authorized in step 110, or it could be several days/months later. It does not matter because the funds are already blocked, and the co-pay amount will not change. In step 130 the insurance company recognizes the claim and authorizes payment. This could be accomplished electronically or through more traditional methods.

Note that the Processor contacted to obtain payment using the patient's payment information (i.e. the patient's credit card in step 50) may be a separate Processor than the one contacted to obtain insurance information in step 60.

It is understood that a significant benefit of this instant invention is that the complex distributed processing between the multiple independent applications of the Mobile Data Storage Device is accomplished at the point of sale location, thus allowing the Processor to act merely as a clearing-house for the information. Nevertheless, it is possible to conduct portions of, or the entire, complex distributed processing at other locations such as the insurance company or even the Processor (or some other central clearing-house location) without departing from the spirit and scope of the instant invention.

It is also understood that another significant benefit of this instant invention is that the complex distributed processing between the multiple independent applications is recorded and reported in a thorough and straightforward manner so as to facilitate verification of past payments and accurate estimation of future benefits.

The Mobile Data Storage Device of the instant invention can be a smart phone or other device having processing capabilities or can be a Smart Card such as either a memory card or a multi-function, microprocessor card. It is even possible that a magnetic strip could be used to store information instead of, or in combination with a chip of a Smart Card, or that some other combination of multiple data storage devices may be used. In some embodiments, the instructions are in the form of a code or other identifier that is input into a point of sale terminal and not stored on a physical medium of the patient/user. If a memory card (or some other storage medium without a microprocessor) is used, the complex distributed processing discussed above will typically take place at the POS device. Nevertheless, the information stored on the card (or other data storage medium) will act as the hub (intersection, junction, nexus, node) for this distributed processing. The information located on the card permits all necessary information, such as insurance policy information and patient's credit card information (for patient's portion of co-pay) to be collected at a single location (whether actually collected on the card, at the POS device or from the Processor's system) so that the determination of payment allocation can be made at that location. This processing allows information to be gathered from multiple sources (insurance company, credit card company, etc.) without any co-mingling of information between the sources. The information is only co-mingled at the location where the distributed processing takes place, which is where all the collected information is needed.

An important aspect of the instant invention is the fact that multiple forms of payment for a procedure are merged or bundled into a single product, but recorded and reported such that they can be distinguished from each other. Essentially, the instant invention allows the card holder's insurance benefits to be combined with their credit card (or other preferred payment vehicle) into one simple payment mechanism while maintaining individual recording and reporting capabilities. The cardholder is essentially empowered by knowing up front how much a procedure will cost the patient out-of-pocket and that payment for the entire procedure can be accomplished. The patient and dentist both know that payment will be made because credit has been pre-approved from all payment sources.

Although the instant invention has been described in the context of healthcare (dental or medical), it is understood that the merging of multiple forms of payment into a single payment vehicle can be applied to numerous applications outside the healthcare industry.

The Mobile Data Storage Device and recording/reporting technology provides security to the card holder that is HIPPA compliant using such features as PIN codes, firewalls, special codes, and infinite rolling codes. Transmission of data to and from the POS device and each protocol will be secure either by using a private network (Processor), encryption of data, or point to point networks. Communication methods could include telephone lines, wireless technology, DSL, cable modems and the like.

It will be appreciated that in some embodiments the Mobile Data Storage Medium is a Smart Card. In other embodiments, the Mobile Data Storage Medium is a smart phone or other device now known or later developed. In some embodiments, a smart card will operate in coordinated fashion with a smart phone. In some such embodiments, the processing requirements for reporting transactions, storing transaction data, and/or providing convergence information are performed by the smart card, and the smart phone operates as a display and input device.

In some embodiments, the apps or layers of the Mobile Data Storage Medium are capable of being updated by a point of sale terminal, or through other means (such as via an internet connection, or via a reader/writer of the user). In this manner, new functionality and/or instructions are capable of being added to the Mobile Data Storage Medium. This allows the user to update desired or required payment instructions based on changes to payment sources. This also allows the payment source parties to update based upon plan or rule changes. In some embodiments, the Mobile Data Storage Medium is able to update instructions/data of the point of sale terminal. In some embodiments, the Mobile Data Storage Medium include initial convergence information that is determined by the patient/user, but that is capable of being updated dynamically by one or more parties. For example, in some embodiments, the convergence information set in the Mobile Data Storage Medium is capable of “conceding” to instructions from one of the payment source parties. In some embodiments, the convergence information will concede to a “best” order that is determined by the point of sale terminal (or at the point of sale terminal) based upon information from the card and/or from the payment sources.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A payment system comprising:
a mobile data storage device for storing payment information associated with first and second payment sources; and
at least one processor for executing a payment protocol and a reporting protocol,
wherein the payment protocol is configured to determine a first payment amount associated with a current procedure,
wherein the reporting protocol is configured to generate a first report, the first report comprising payment information associated with the first payment, and
wherein the first payment amount is an amount to be paid by the first payment source.

2. The payment system of claim 1, wherein:
the first payment source is an insurance provider;
the payment information comprises threshold information;
the threshold information comprises at least one of insurance limits, insurance usage, remaining insurance coverage, deductible information, and co-payment information associated with the first payment source;
the payment protocol utilizes the threshold information while determining the first payment amount, and
the first report comprises threshold information.

3. The payment system of claim 2, wherein the payment information comprises information associated with one or more prior payment associated with one or more prior procedure, such prior payment affecting one or more threshold value, thereby affecting the value of the first payment.

4. The payment system of claim 1, wherein the payment protocol is configured to determine a second payment amount associated with the current procedure and the reporting protocol is configured to generate a second report, the second payment amount being an amount to be paid by the second payment source and the second report comprising payment information associated with the second payment.

5. The payment system of claim 4, wherein:
the first payment source is an insurance provider;
the second payment source is an insurance provider;
the payment information comprises threshold information;
the threshold information comprises at least one of insurance limits, insurance usage, remaining insurance coverage, deductible information, and co-payment information associated with the first and second payment sources;
the payment protocol utilizes the threshold information while determining the first and second payment amounts, and
each of the first and second reports comprise threshold information.

6. The payment system of claim 5, wherein the payment information comprises information associated with one or more prior payment associated with one or more prior procedure.

7. The payment system of claim 4, wherein:
the first payment source is an insurance provider;
the second payment source is a savings account;
the payment information comprises threshold information;
the threshold information comprises at least one of insurance limits, insurance usage, remaining insurance coverage, deductible information, and co-payment information associated with the first payment source;
the threshold information comprises account balance information associated with the second payment source;
the payment protocol utilizes the threshold information while determining the first and second payment amounts, and
each of the first and second reports comprise threshold information.

8. The payment system of claim 7, wherein the payment information comprises information associated with one or more prior payment associated with one or more prior procedure.

9. The payment system of claim 7, wherein the savings account is a pre-tax savings account.

10. The payment system of claim 4, wherein the mobile data storage device stores payment information associated with a third payment source, the payment protocol being configured to determine a third payment to be paid by the third payment source, the third payment amount being associated with the current procedure.

11. A method of determining one or more payment amount associated with a current procedure, the method comprising:
storing on a mobile data storage device information associated with first and second payment sources; and
utilizing at least one processor to execute a payment protocol and a reporting protocol,
wherein the payment protocol determines a first payment amount associated with a current procedure,
wherein the reporting protocol generates a first report, the first report comprising payment information associated with the first payment, and
wherein the first payment amount is an amount to be paid by the first payment source.

12. The method of claim 11, wherein:
the first payment source is an insurance provider;
the payment information comprises threshold information;
the threshold information comprises at least one of insurance limits, insurance usage, remaining insurance coverage, deductible information, and co-payment information associated with the first payment source;
the payment protocol utilizes the threshold information while determining the first payment amount, and
the first report comprises threshold information.

13. The method of claim 12, wherein the payment information comprises information associated with one or more prior payment associated with one or more prior procedure, such prior payment affecting one or more threshold value, thereby affecting the value of the first payment.

14. The method of claim 11, wherein the payment protocol determines a second payment amount associated with the current procedure and the reporting protocol generates a second report, the second payment amount being an amount to be paid by the second payment source and the second report comprising payment information associated with the second payment.

15. The method of claim 14, wherein:
the first payment source is an insurance provider;
the second payment source is an insurance provider;
the payment information comprises threshold information;
the threshold information comprises at least one of insurance limits, insurance usage, remaining insurance coverage, deductible information, and co-payment information associated with the first and second payment sources;
the payment protocol utilizes the threshold information while determining the first and second payment amounts, and
each of the first and second reports comprise threshold information.

16. The method of claim 14, wherein:
the first payment source is an insurance provider;
the second payment source is a savings account;
the payment information comprises threshold information;
the threshold information comprises at least one of insurance limits, insurance usage, remaining insurance coverage, deductible information, and co-payment information associated with the first payment source;
the threshold information comprises account balance information associated with the second payment source;
the payment protocol utilizes the threshold information while determining the first and second payment amounts, and
each of the first and second reports comprise threshold information.

17. The method of claim 14, wherein the mobile data storage device stores payment information associated with a third payment source and wherein the payment protocol determines a third payment to be paid by the third payment source, the third payment amount being associated with the current procedure.

18. An information system comprising:
a mobile data storage device for storing source information associated with first and second sources; and
a processor for executing a determination protocol, the determination protocol being configured to determine a first value associated with a current consideration,
wherein the first value is associated with the first source,
wherein the source information comprises at least one threshold value associated with the first source, and
wherein the determination protocol is configured to determine the first value based on the at least one threshold value associated with the first source.

19. The information system of claim 18, wherein the source information comprises information associated with one or more prior value associated with one or more prior consideration, such prior value affecting the value of the first value.

20. The information system of claim 19, wherein the determination protocol is configured to determine a second value associated with the current consideration, the second value being associated with the second source, wherein the source information comprises at least one threshold value associated with the second source, and wherein the determination protocol is configured to determine the second value based on the at least one threshold value associated with the second source.
